(19) United States
(12) Patent Application Publication
(10) Pub. No.: US 2007/0253006 A1
(43) Pub. Date: Nov. 1, 2007

(54) Print user interface

(75) Inventor: Samuel P. Mordenga, Rochester, NY (US)

Correspondence Address: Miele Law Group PC, 36 Lovering Street, Medway, MA, 02053, US

(73) Assignee: Xerox Corporation

(21) Appl. No.: 11/412,625

(22) Filed: Apr. 27, 2006

(51) Int. Cl. G06F 3/12

(52) U.S. Cl. 358/1.1

(57) ABSTRACT

In accordance with one embodiment of the disclosure, apparatus are provided. A stored shape representation and stored status information are each provided. The stored shape representation is a representation of a shape of a marking device. The marking device includes subsystems including one or more paper trays, one or more finishing devices, and additional subsystems. The stored status information is information concerning the respective statuses of the subsystems. An association mechanism is provided to associate the status information with corresponding portions of the shape of the marking device. A status change mechanism is provided to change a given status of the subsystems by operating a corresponding given graphical tool associated on a computer screen with the portion of the shape that corresponds with the given status.

### FIELD OF THE DISCLOSURE

The present disclosure is related to user interfaces for marking devices with printer functions.

### BACKGROUND

Computer system users frequently access peripheral marking devices, such as, for example, printers, laser printers, inkjet printers, or multi function devices including a printer portion. The computer system interacts with such peripheral devices via a device driver. A marking device driver, which is a device driver for a marking device (e.g., a printer or a multi function device), translates computer data into a form understood by the marking device. The driver may manipulate the hardware in order to transmit the data to the device, or the driver may perform only data translation, and rely upon lower-level drivers to actually send the data to the device. Marking device drivers typically include a user interface which allows a user to monitor the status of various subsystems of the marking device as well as to control and change statuses of the subsystems.

### SUMMARY

In accordance with one aspect of the disclosure, apparatus are provided. As part of the apparatus, a stored shape representation is provided. The stored shape representation is of a shape of a marking device. The marking device includes subsystems including one or more paper trays, one or more finishing devices, and additional subsystems. Stored status information is provided concerning respective statuses of the subsystems. An association mechanism is provided to associate the status information with corresponding portions of the shape of the marking device. A status change mechanism is provided to change a given status of the subsystems by operating a given graphical tool associated on a computer screen with the portion of the shape that corresponds with the given status.

### BRIEF DESCRIPTION OF THE DRAWINGS

Embodiments of the disclosure are further described in the detailed description which follows by reference to the noted drawings, in which like reference numerals represents similar parts throughout the several views of the drawings, and wherein:

FIG. 1 is a schematic block diagram of a computer hardware platform, including a virtual machine print driver interface;

FIG. 2 is a schematic block diagram of an application program screen or window, including a virtual machine print driver icon;

FIG. 3 is a diagram of a screen including a displayed shape representation of a marking device in accordance with one example embodiment; and

FIG. 4 is a schematic block diagram illustrating the inter-relationship between an application program, a generic laser printer interface, and a vender-specific print driver.

### DETAILED DESCRIPTION

One aspect of the present disclosure is directed to a user interface for the operation, control, and/or setup of marking devices (for example, a printer or a multi-function device including a printer). The user interface includes a displayed shape representation of the marking device. Another aspect of the present disclosure is directed to a driver for a marking device (e.g., a printer) that includes such a user interface.

Another aspect of the present disclosure is directed to a user interface for controlling a printer's operation, control, and/or setup, which is presented as a displayed shape representation of the marking device, and to a generic print driver. The generic print driver provides such a user interface, and allows such a user interface to interact with different vender-specific print drivers.

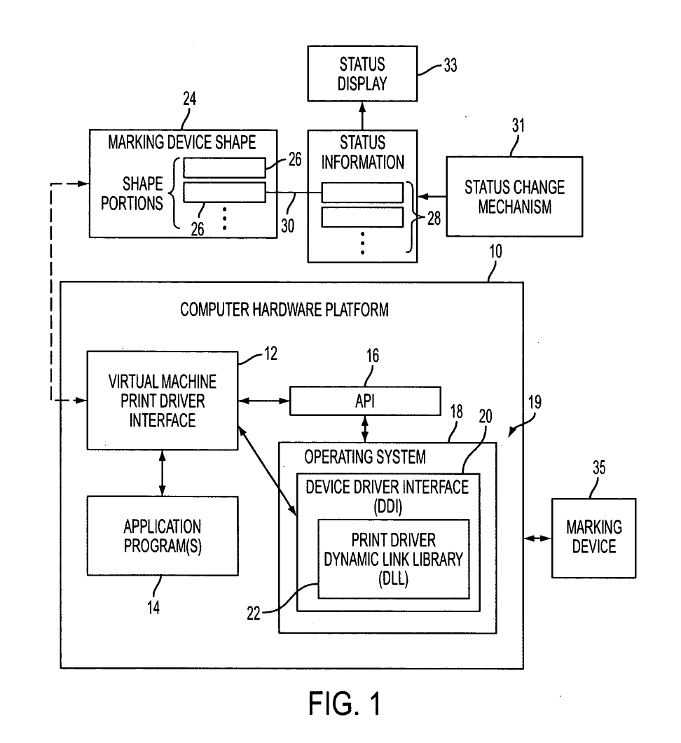

Referring now to the drawings in greater detail, FIG. 1 is a block diagram of one embodiment of a computer hardware platform 10. The illustrated computer hardware platform 10 includes, among other elements not specifically shown, a virtual machine print driver interface 12, one or more application programs 14, an API (application program interface) 16 and lower level software 19, which includes an operating system 18, a device driver interface (DDI) 20, and a print driver dynamic link library (DLL) 22.

The application program or programs 14, may, for example, include a word processing program such as Microsoft Word®, spreadsheet software, document manager software, Microsoft PowerPoint, or any other application program that concerns the formation, modification, and printing of documents. The virtual machine print driver interface 12 includes software which causes the display of a shape of a marking device, which marking device is accessible by the application program or programs 14 for marking media (e.g., printing on paper) in accordance with a document file defined by the application program. For example, an application program 14 may allow a user to interact with a computer screen which includes a graphical display of the shape of a marking device. The user may interact with the graphical shape representation of the marking device, e.g., to cause printing of a document, to access status information concerning subsystems of the marking device, and/or to change a given status of one or more subsystems of the marking device. The given status may be changed, for example, by manipulating a given graphical tool associated on the computer screen with a portion of the shape that corresponds with the given status.

The computer hardware platform 10 further includes an API 16, which serves as go-between software between application program or programs 14 and operating system 18. The application program or programs 14 interact with a device driver interface 20, which may, for example, be implemented using a print driver dynamic link library 22 (for example, using a sixteen-bit print driver DLL, typically provided in computers operating with Windows 3.X, Windows 95, Windows 98, Windows XP, and Windows Me).

Virtual machine print driver interface 12 may be provided as part of one of an application program 14, API 16, operating system 18, or a particular device driver. Alternatively, virtual machine print driver interface 12 may be implemented with separate software.

Virtual machine print driver interface 12 may be unique to a particular marking device, or it may be provided as a generic print driver which serves as an interface between the one or more application programs 14 and different vendor-specific print drivers.

The stored shape representation of a shape of a marking device may be stored, for example, in a random access memory (RAM) of the computer hardware platform, in a register, in a disk, or in the system's cache memory. The stored shape representation may be stored in one file, in different files, and as contiguous or as separate data.

The marking device may be a printer or a multi-function device including a printer portion. If the marking device is a printer, the printer may be a laser printer or an inkjet printer. The marking device may include subsystems such as one or more paper trays, one or more finishing devices, and additional subsystems. The one or more finishing devices may include, for example, a stapler and a collater. The additional subsystems may include, for example, a halftoning mechanism, a two-sided printing mechanism, settings for two-sided printing, and a scaling function for scaling of printed documents. The additional subsystems may further include a manual feeder, and color and mono print output settings for the marking device.

As shown in FIG. 1, a virtual machine print driver interface 12 may include a stored shape representation 24 of a shape of a marking device. The stored shape representation 24 may include a plural set of shape portions 26 which include data representing the respective shapes of certain portions of the marking device as well as of the overall shape of the marking device. In addition, virtual machine print driver interface 12 may include a stored representation of status information 28 concerning respective statuses of the subsystems of the marking device. An association mechanism 30 is provided to associate the status information with corresponding shape portions 26. The association mechanism 30 may include, for example, a data structure or database function for associating each shape portion 26 with certain status information 28 that corresponds to that shape portion.

A status change mechanism 31 may be provided to change a given status 28, plural statuses 28, or of all the statuses 28 of the subsystems, e.g., by operating a given graphical tool associated (on a computer screen displaying the shape portions) with the shape portion 28 that corresponds with those statuses. The given graphical tool may involve, for example, clicking a mouse while a cursor is over or near the shape portion that corresponds to the status. A status display 33 may be provided to display a given status at a corresponding portion of the shape. The given status may be displayed in response to operation of a graphical tool. That graphical tool may be located at the corresponding shape portion, over the shape portion, and/or near the shape portion. In addition, the graphical tool may include a line or arrow pointing to the corresponding shape portion.

A graphical tool may include, for example, an icon, a text display and/or input element, a form, or an icon. The graphical tool may interact with a positionable curser.

A marking device 35 may be provided. The marking device 35 may include a printer or a multi-function device including a printer portion, in each case accompanied with software interoperable with the computer hardware platform 10, to cause, upon installation, the creation in the platform of a stored shape representation, stored status information, and a status change mechanism.

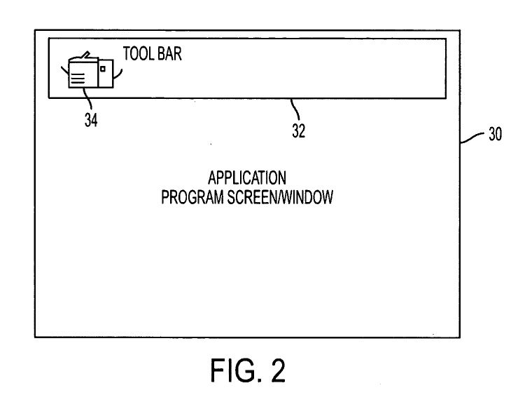

FIG. 2 is a schematic diagram of an application program screen or window 30. The illustrated screen or window 30 may be a specific screen or window of a given application on a computer. Somewhere on screen or window 30, a tool region 32 may be provided. In the illustrated embodiment, the tool region 32 is a tool bar. Within tool bar 32, a virtual machine print driver icon 34 may be provided. The icon 34 is a miniature representation of the shape of the marking device, which, when clicked on (either with a single click or a double click, depending upon how the software is configured), will provide access to a more detailed graphic representation of the marking device, where each of the shaped portions of the marking device will be viewable and can be interacted with to view status information and to change the status information, in the manner described above.

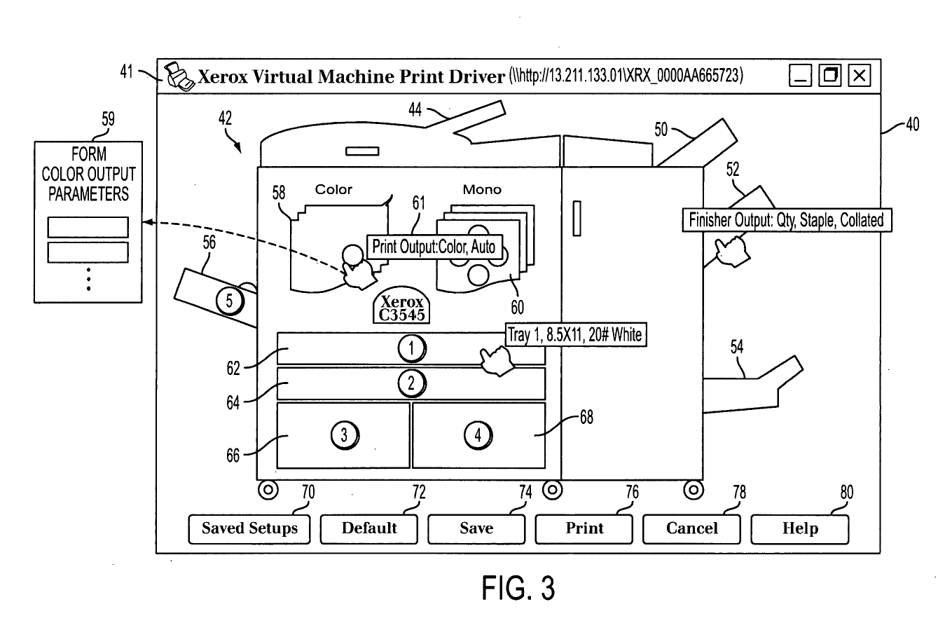

FIG. 3 is a schematic diagram of a virtual machine print driver graphical representation 42, which may be displayed upon activation or clicking of icon 34 in FIG. 2.

FIG. 3 shows a print device status screen 40. At the top of screen 40 is a title bar 41. In the body of the screen or window, a displayed shape representation 42 is provided. The illustrated shape representation 42 includes graphical representations of the various subsystems of the marking device. Those subsystems are represented by shape portions, including a document feeder mechanism 44, color print settings 58, mono print settings 60, paper trays 62, 64, 66, and 68, and a manual feeder 54. In addition, shaped portions are provided representing other subsystems, including a shape representation for a by-pass output feed 56, a top tray output 50, and a finisher 52.

The window also has in a bottom region a number of driver control buttons, including a saved setups button 70, a default operating button 72, a save button 74, a print button 76, a cancel button 78, and a help button 80.

As shown in FIG. 3, when a curser is positioned over a particular shape portion, an identifier element (e.g., identifier element 61, which indicates that the shape portion corresponds to print output options such as color and auto) will be displayed to the user, allowing the user to see the type of subsystem settings that can be accessed by clicking on that shape portion.

Once the user clicks on the shape portion over which the curse is positioned, the graphical tool that allows for the display of the settings for that subsystem as well as for modification of those settings will be displayed. For example, as shown in FIG. 3, when the color shape portion 58 is clicked, a form 59 may be displayed, which allows the user to both view and modify the color output parameters for the marking device.

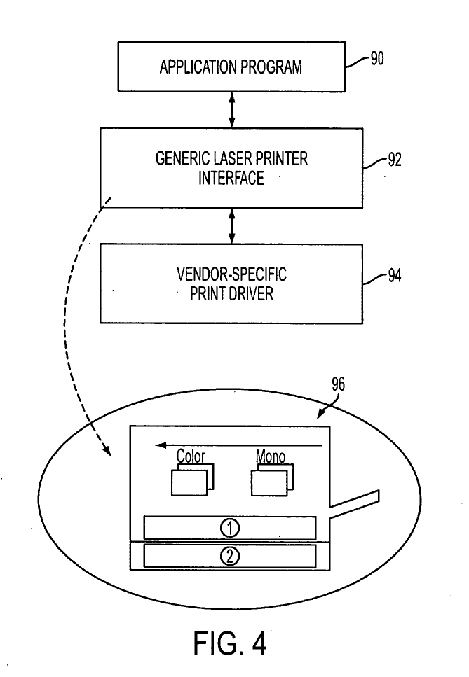

FIG. 4 illustrated the overall structure of a computer system employing a generic laser printer interface 92. Specifically, an application program 90 interacts with a generic laser printer interface 92, which in turn communicates with a vender-specific print driver 94. The generic laser printer interface 92 presents in a displayed form a displayed shape representation 96, which, in a manner similar to that shown and described above with respect to FIG. 3, allows a user to view and change settings of the various subsystems of a laser printer, while the shape portions and the configuration of the displayed shape representation 96 will be generic to different types of vender-specific printers. The underlying software of generic laser printer interface 92 will then communication with the vender-specific print driver 94, to obtain the status information for display in connection with displayed shape representation 96, or for modification of those settings.

Accordingly, software may be provided to allow a user to control the settings to view and alter the settings of different types of printers by interacting with their print drivers, via a generic laser interface 92 as shown in FIG. 4. A given computer platform may include a plurality of different print drivers, which may be multi-function devices, laser printers, or inkjet printers. In the illustrated embodiment, those print drivers are for laser printers. A different generic displayed shape representation 96 may be provided for different types of devices, for example, if the marking device is a multi-function device or an inkjet printer.

A graphical tool may include, for example, an icon or button that can be activated by clicking a mouse with a curser situated over the icon or button. A graphical tool may include a form or textual input represented on a computer screen. A graphical tool may include a menu of displayed symbols or text that could be chosen by pointing to and clicking over a given symbol or text. A graphical tool can also include a drop-down menu, or any other type of graphical tool. Alternatively, other tools may be provided to allow a user to control and operate various functions referred to in the interfaces depicted herein, for example, with the use of a command line type interface.

The processing or functions performed by the elements shown in the figures herein may be performed by a general-purpose computer and/or by a special purpose computer. Such processing or functions may be performed by a single platform or by a distributed processing platform. Any data handled in such processing or created as a result of such processing can be stored in any type of memory. By way of example, such data may be stored in a temporary memory, such as in the random access memory of a given computer. In addition, or in the alternative, such data may be stored in longer-term storage devices, for example, magnetic disks, rewritable optical disks, and so on. For the disclosure herein, machine-readable media may include any form of data storage mechanism as well as hardware and circuit representations of the structures or data that a data storage mechanism might hold.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
a stored shape representation of a shape of a marking device, the marking device including subsystems including one or more paper trays, one or more finishing devices, and additional subsystems;
stored status information concerning respective statuses of the subsystems;
an association mechanism to associate the status information with corresponding portions of the shape of the marking device; and
a status change mechanism to change a given status of the subsystems by operating a corresponding given graphical tool associated on a computer screen with the portion of the shape that corresponds with the given status.

2. The apparatus according to claim 1, wherein the stored shape representation and the stored status information are each stored in one or more of a random access memory, a register, a disk, and a cache.

3. The apparatus according to claim 2, wherein the shape of the marking device includes a facsimile of the marking device including traces of profile of the entire marking device and of each driver adjustment subsystem thereof.

4. The apparatus according to claim 3, wherein the marking device includes a printer.

5. The apparatus according to claim 3, wherein the marking device includes a laser printer.

6. The apparatus according to claim 3, wherein the marking device includes an inkjet printer.

7. The apparatus according to claim 3, wherein the marking device includes a multi-function device including a printer portion.

8. The apparatus according to claim 3, wherein the additional subsystems include a halftoning mechanism, a two-sided printing mechanism, a scaling function for scaling of printed documents, a manual feeder, and color and mono print output settings.

9. The apparatus according to claim 3, wherein the respective statuses of the subsystems include a presence or absence of paper in a given paper tray.

10. The apparatus according to claim 3, wherein the association mechanism includes a data structure.

11. The apparatus according to claim 3, wherein the status change mechanism includes a mechanism to change plural statuses of the subsystems by operating a given graphical tool associated on the computer screen with the portion of the shape that corresponds with the given status.

12. The apparatus according to claim 3, wherein the status change mechanism includes a mechanism to change any of all statuses of the subsystems by operating a given graphical tool associated on the computer screen with the portion of the shape that corresponds with those statuses.

13. The apparatus according to claim 3, further comprising a status display mechanism to display a given status at a corresponding portion of the shape in response to operation of a graphical tool.

14. The apparatus according to claim 13, wherein a graphical tool includes one of an icon, a text display and input element, a form, and a graphical user interface element that interacts with a positionable curser.

15. The apparatus according to claim 14, further comprising a given marking device accompanied with software interoperable with a computer to cause creation of the stored shape representation, the stored status information, and the status change mechanism.

16. The apparatus according to claim 3, wherein the status change mechanism comprises a print driver to interact directly with the marking device.

17. The apparatus according to claim 3, wherein the status change mechanism comprises a generic print driver to interact with plural different print drivers tailored to respective different marking devices.

18. A method comprising:
providing stored shape representation of a shape of a marking device, the marking device including subsystems including one or more paper trays, one or more finishing devices, and additional subsystems;
providing stored status information concerning respective statuses of the subsystems;
associating the status information with corresponding portions of the shape of the marking device; and
changing a given status of the subsystems by operating a corresponding given graphical tool associated on a computer screen with the portion of the shape that corresponds with the given status.

19. Machine-readable media encoded with data, the encoded data interoperable with a machine to cause:
providing a stored shape representation of a shape of a marking device, the marking device including subsystems including one or more paper trays, one or more finishing devices, and additional subsystems;
providing stored status information concerning respective statuses of the subsystems;
associating the status information with corresponding portions of the shape of the marking device; and
changing a given status of the subsystems by operating a corresponding given graphical tool associated on a computer screen with the portion of the shape that corresponds with the given status.
